(19) United States
(12) Patent Application Publication
(10) Pub. No.: US 2025/0268690 A1
(43) Pub. Date: Aug. 28, 2025

(54) FEM ANALYSIS FOR THE PRODUCTION OF DENTAL RESTORATIONS

(71) Applicant: Ivoclar Vivadent AG, Schaan (LI)

(72) Inventor: Atilim Eser, Lindau (DE)

(21) Appl. No.: 19/062,435

(22) Filed: Feb. 25, 2025

(30) Foreign Application Priority Data
Feb. 27, 2024 (EP) 24159881.2
Feb. 12, 2025 (EP) 25157416.6

(51) Int. Cl. A61C 5/77; A61C 13/00

(52) U.S. Cl. CPC A61C 5/77; A61C 13/0004; A61C 13/0006

(57) ABSTRACT

A method of building a dental restoration, including the steps of providing (S101) a three-dimensional data set indicating the spatial shape of the dental restoration and a spatial distribution of at least one production material within the dental restoration; simulating (S102) a spatial stress distribution within the dental restoration at a predetermined load based on the three-dimensional data set; and changing (S103) the three-dimensional data set based on the simulated stress distribution.

### CROSS-REFERENCE TO RELATED APPLICATIONS

This application claims priority to European Patent Application No. 24159881.2 filed on Feb. 27, 2024 and European Patent Application No. 25157416.6 filed on Feb. 12, 2025, both of which are incorporated herein by reference in their entirety.

### TECHNICAL FIELD

The present invention relates to a method of building a dental restoration, a computer program product and a production apparatus.

### BACKGROUND

Mechanical stress peaks can occur in dental restorations under load, which can lead to fracture or damage to the dental restoration.

U.S. Pat. No. 11,737,859 and 20060131770 are related to methods of producing dental restorations and/or dental models and are hereby incorporated by reference in their entirety.

### SUMMARY

It is the technical task of the present invention to improve the stability of dental restorations.

This task is solved by subject-matter according to the independent claims. Advantageous embodiments are the subject-matter of the dependent claims, the description and the figures.

According to a first aspect, the present task is solved by a method of building a dental restoration, comprising the steps of providing a three-dimensional data set indicating the spatial shape of the dental restoration and a spatial distribution of at least one production material within the dental restoration; simulating a spatial stress distribution within the dental restoration at a predetermined load based on the three-dimensional data set; and changing the three-dimensional data set based on the simulated stress distribution. Changing the data set can be done by changing the shape and/or material composition represented by the data set. This achieves the technical advantage that stress peaks within the dental restoration can be recognized and constructively reduced and an overall more homogeneous stress distribution within the dental restoration is achieved.

In a technically advantageous embodiment of the method, the surface of the dental restoration is imaged using triangular facets. This achieves the technical advantage, for example, that the spatial shape of the dental restoration can be easily detected.

In a further technically advantageous embodiment of the method, the triangular facets have a smaller area in a region between two teeth or in a region of an occlusal surface than in another region of the dental restoration, such as in a region of the lateral surface of the tooth. This achieves the technical advantage, for example, that the stress distribution can be calculated quickly and with a high degree of accuracy.

In a further technically advantageous embodiment of the method, the spatial shape of the dental restoration is changed, for example to reduce stress peaks. This achieves the technical advantage, for example, that the shape of the dental restoration can be adapted locally in a targeted manner.

In a further technically advantageous embodiment of the method, a local region of the shape is expanded if a stress within the stress distribution of the local region is above a predetermined threshold value, and/or a local region of the shape is reduced, if a stress within the stress distribution of the local region is below a predetermined threshold value. This achieves the technical advantage, for example, that a better stress distribution is achieved within the dental restoration and stress peaks are reduced.

In a further technically advantageous embodiment of the method, a connecting cross-section between two teeth of the dental restoration is increased, if a stress within the stress distribution is above a predetermined threshold value, and/or a connecting cross-section between two teeth of the dental restoration is reduced if a stress within the stress distribution is below a predetermined threshold value. This also achieves the technical advantage, for example, that a better stress distribution within the dental restoration or a more natural appearance is achieved and stress peaks are reduced.

In a further technically advantageous embodiment of the method, the production material is replaced in a spatial region when a stress within the stress distribution is above or below a predetermined threshold value, for example to reduce stress peaks. For example, a second production material can be used in the spatial region instead of a first production material. In this case, one production material is replaced by another production material and the stress distribution is simulated again. This achieves the technical advantage, for example, that a stronger production material can be used in the case of a high stress and a less strong production material can be used in the case of a lower stress.

In a further technically advantageous embodiment of the method, a first production material is assigned to a first spatial region of the dental restoration and a second production material is assigned to a second spatial region of the dental restoration. This achieves the technical advantage, for example, that a structure with several materials is achieved.

In a further technically advantageous embodiment of the method, the material parameters of predefined production materials are retrieved from a database to simulate the stress distribution. This achieves the technical advantage, for example, that the material properties of numerous production materials can be retrieved.

In a further technically advantageous embodiment of the method, the stress distribution is simulated again with the changed shape and/or the changed production material. This achieves the technical advantage, for example, that a specific production material is used depending on the calculated stress.

In a further technically advantageous embodiment of the method, the method steps are repeated iteratively. This achieves the technical advantage, for example, that the structure of the dental restoration is successively improved.

In a further technically advantageous embodiment of the method, an iterative repetition of the method steps is terminated when a stress within the stress distribution falls below or exceeds a predetermined value. This achieves the technical advantage, for example, that the method is terminated with little computational effort.

In a further technically advantageous embodiment of the method, the simulation of the spatial stress distribution is based on a finite element method. This achieves the technical advantage, for example, that the stress distribution can be calculated particularly efficiently.

In a further technically advantageous embodiment of the method, the dental restoration is a prosthesis, bridge or crown. This achieves the technical advantage, for example, that the method is particularly suitable for these restorations.

In a further technically advantageous embodiment of the method, the three-dimensional data set is transmitted to a production apparatus and the dental restoration is produced. This achieves the technical advantage, for example, of simplifying the production of the dental restoration.

In a further technically advantageous embodiment of the method, a material-specific minimum value is reduced in the production of the dental restoration and/or a material-specific maximum value is exceeded in the production of the dental restoration.

In a further technically advantageous embodiment of the method, the production apparatus is a 3D printer or a milling machine. This achieves the technical advantage, for example, that the dental restoration can be produced in a simple manner.

According to a second aspect, the present task is solved by a computer program comprising instructions which, when the computer program is executed by a computer, cause the computer to execute the method according to the first aspect. The computer program achieves the same technical advantages as the method according to the first aspect. A computer program product comprises program code which is stored on a non-transitory machine-readable medium. The machine readable medium comprises computer instructions executable by a processor, which computer instructions cause a controller to perform the methods described herein.

According to a third aspect, the present task is solved by a production apparatus comprising a computer program according to the second aspect. The production apparatus achieves the same technical advantages as the method according to the first aspect.

### BRIEF DESCRIPTION OF THE DRAWINGS

Exemplary embodiments of the invention are shown in the drawings and are described in more detail below, in which: FIG. 1 shows a view of a stress distribution within a dental restoration;

FIG. 2 shows another view of the stress distribution within the dental restoration;

FIG. 3 shows a view of a three-dimensional data set of a dental restoration with a predetermined load;

FIG. 4 shows a view of a three-dimensional data set of a dental restoration divided into triangular facets;

FIG. 5 shows a view of a three-dimensional data set of a dental restoration with metal bar;

FIG. 6 shows a view of a three-dimensional data set of a permanent and a temporary dental restoration;

FIG. 7 shows a view of a dental restoration with different strength values;

FIG. 8 shows a view of a change in the load site on the dental restoration;

FIG. 9 shows a diagram for a static fracture and a fatigue fracture; and

FIG. 10 shows a block diagram of a method of building a dental restoration.

### DETAILED DESCRIPTION

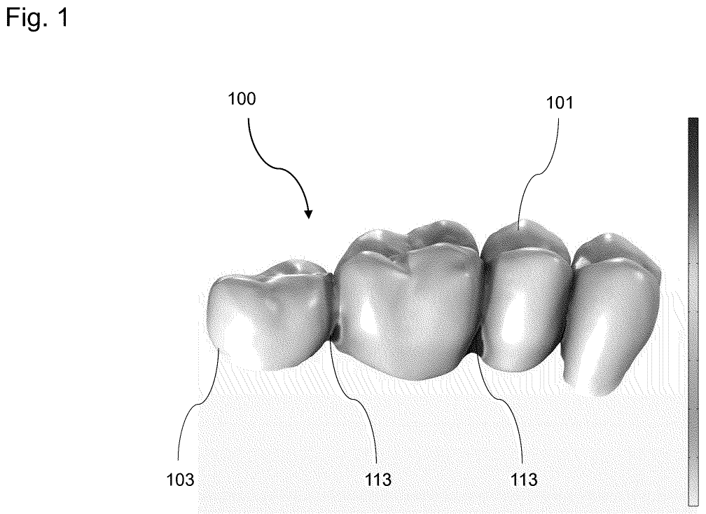

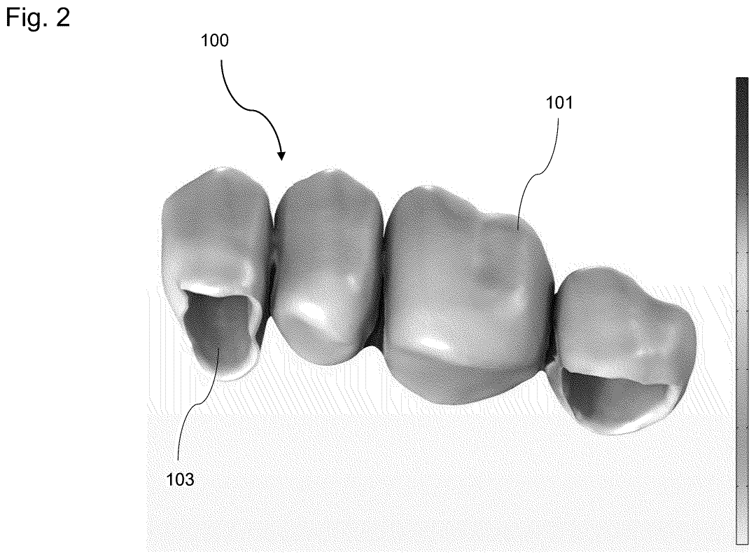

FIGS. 1 and 2 show a stress distribution 113 within a dental restoration 100. The dental restoration 100 is, for example, a prosthesis, a crown or a bridge. The finite element method can be used to calculate the stress distribution 113. The finite element method (FEM) is used in the strength analysis of solid bodies with geometrically complex shapes. Logically, the finite element method is based on the numerical solution of a complex system of differential equations.

The finite element method is used to simulate the stress distribution 113 under a predetermined load on the dental restoration 100 based on the spatial shape, the spatial distribution of the production materials 101 used within the dental restoration 100 with the material properties of the production materials 101 used. The spatial shape is given, for example, by the outer surface of the dental restoration 100.

The strength of the dental restoration 100 depends, for example, not only on a layer thickness of the production materials 101 or the size of a connecting cross-section between two teeth, but also on the more precise shape of the dental restoration 100. For example, a dental bridge with a smaller connecting cross-section between two teeth can withstand higher masticatory forces than another dental bridge with a larger connecting cross-section.

In addition, different production materials 101 can be arranged and used in different spatial regions inside the dental restoration 100, such as zirconium 3Y-TZP or 5Y-TZP. Depending on the material parameters of the production materials 101, these can be used at different locations and in different regions. For example, a different production material 101 is used in an inner region of the dental restoration 100 than in an outer region.

In a region with a high stress, for example, a production material 101 with a higher strength can be used than in a region with a lower stress. The region in which the production material with a higher strength is used is, for example, a spatial region in which the simulated stress is above a predetermined threshold value. In general, however, any number of production materials 101 can be used to produce the dental restoration 100.

The simulation can be used to calculate a spatial stress distribution 113 within the dental restoration 100. The stress distribution 113 indicates the stress at each location inside the dental restoration. Depending on the calculated stress distribution 113, the three-dimensional data set 103 can then be changed to obtain a stress distribution 113 with a lower maximum stress or a spatially more homogeneous stress. The maximum stress is the greatest stress that occurs within the dental restoration 100 or within a predetermined region. The maximum stress is assessed based on the fatigue strength value of the material, which in turn is determined by fatigue testing the material. Two different load cases are calculated, namely the static and dynamic cases. For the dynamic case, the stress is compared with the fatigue strength value and for the static case with the static strength.

Changing the data set can be achieved by changing the shape of the dental restoration 100 and/or the material distribution and composition of the production materials 101. When changing the shape, certain spatial regions of the dental restoration 100 are spatially enlarged or reduced. As a result, a more homogeneous stress distribution can be achieved and stress peaks can be reduced. When changing the composition, a different production material can be arranged in certain spatial regions than was the case in the simulation calculation. After replacing the production material 101 with a different production material 101, the simulation of the stress distribution 113 can be performed again to determine whether a stress within the stress distribution 113 of the local region is above or below a predetermined threshold value.

Stress peaks within the dental restoration 100 can also be compensated for by changing the production materials. The production materials 101 can, for example, comprise zirconium dioxide with different proportions of yttrium, such as zirconium 3Y-TZP, 4Y-TZP or 5Y-TZP. A simulation of the stress distribution 113 is then carried out again for the changed three-dimensional data set 103.

The approval of a material for certain dental restorations 100 can also be based on the results of the FEM simulations. All production materials 101 are generally approved for all indications. In addition, patient-specific FEM calculations with consideration of masticatory forces can be carried out.

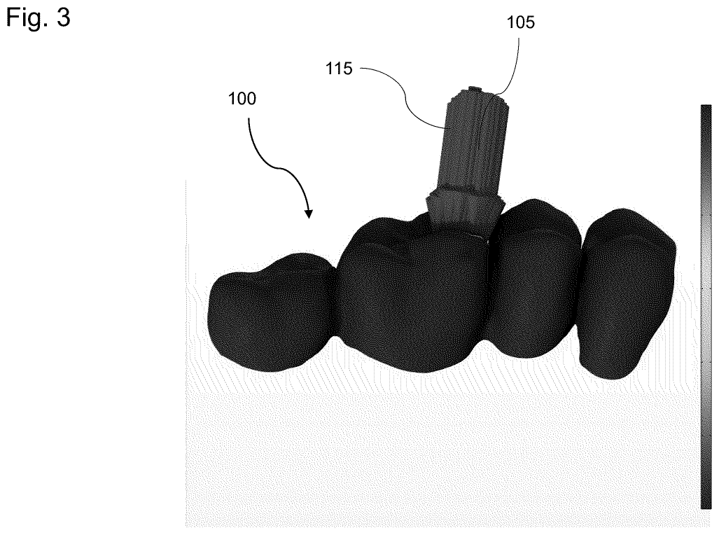

FIG. 3 shows a view of a three-dimensional data set of a dental restoration 100 with a predetermined load 105. The predetermined load 105 is created by a force vector 115 acting mathematically on the dental restoration 100 during simulation. The force vector 115 is, for example, perpendicular to an occlusal surface of the dental restoration 100 or is arranged parallel to the longitudinal axis of a tooth. The force vector 115 typically indicates the force that acts on the dental restoration 100 during chewing.

In the case of a bridge as a dental restoration 100, the force vector 115 can be arranged in the middle of two provided supporting teeth. The amount of the force vector 115 is lower for dental restorations 100 for the anterior tooth region than for dental restorations 100 in the posterior molar region. The amount of the force vector can be calculated in proportion to the tooth number.

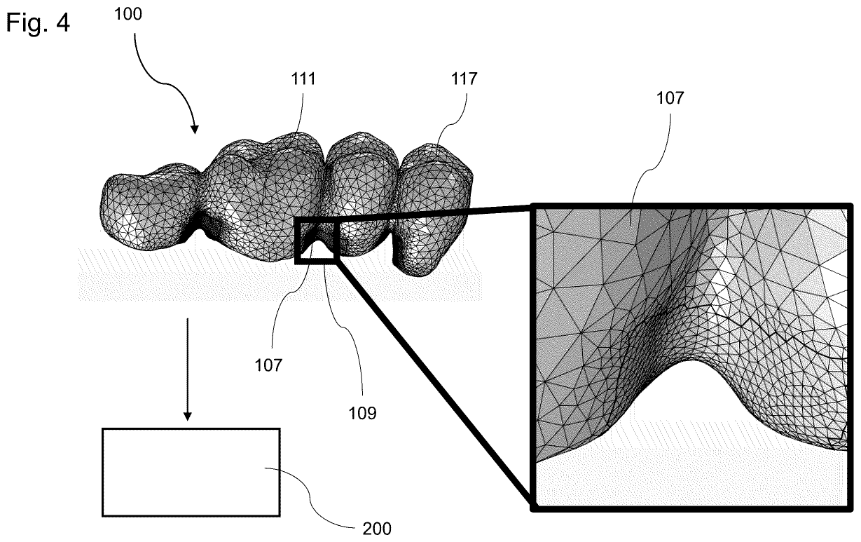

FIG. 4 shows a view of a three-dimensional data set 103 of a dental restoration 100 divided into triangular facets 107. To simulate the stress distribution 113, the surface of the three-dimensional data set is discretized by triangular facets. The triangular facets 107 have a different size depending on their location within the dental restoration 100.

To simulate the spatial stress distribution 113 within the dental restoration 100 under a predetermined load based on the three-dimensional data set, the size of the triangular facets 107 in the region 109 between two modeled teeth or an occlusal surface 117 is reduced, for example.

The area of the respective triangular facets 107 in the region 109 between two modeled teeth or in the region of the occlusal surface 117 is, for example, less than half the area of the triangular facets in region 111, on the central lateral surface of a tooth. Due to the finer meshing, the stress distributions 113 can be calculated with a high degree of accuracy. After the calculation, the three-dimensional data set 103 can be transmitted to a production apparatus 200, which then produces the dental restoration 100 accordingly.

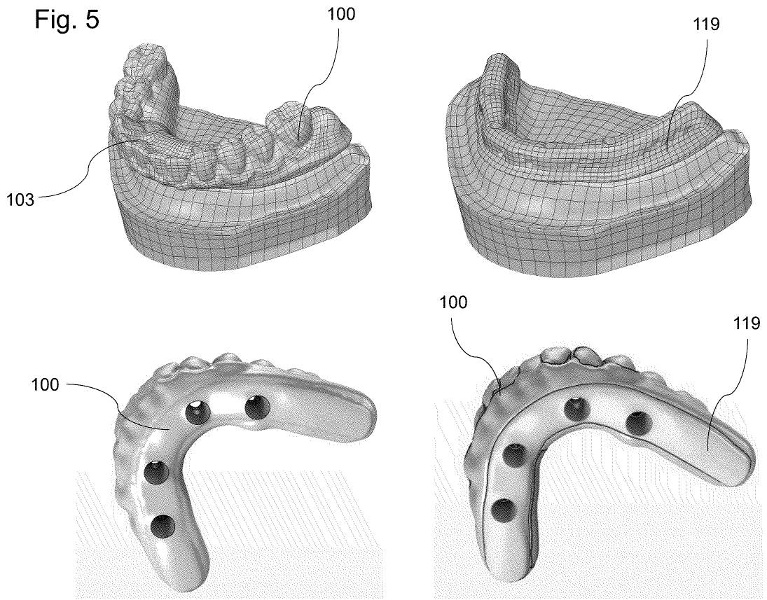

FIG. 5 shows a view of a three-dimensional data set 103 of a dental restoration 100 with metal bar 119. To reinforce the dental restoration 100, the metal bar 119 can be embedded in the dental restoration 100.

If a stress within the stress distribution 113 is above a predetermined threshold value, the metal bar 119 can be automatically embedded in the dental restoration 100 for reinforcement. The metal bar 119 supports the dental restoration 100 along the dental arch. The program can use the simulation results to assess and decide whether or not a metal bar 119 is required for the dental restoration 100 made of plastic.

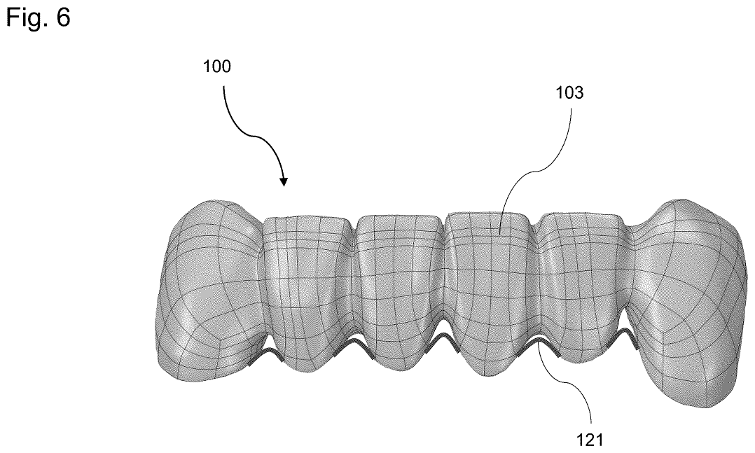

FIG. 6 shows a view of a three-dimensional data set 103 with a permanent dental restoration 100 and a temporary dental restoration 121. A production material with a lower strength is used for a temporary dental restoration 121. The method can be used to adapt the constructed permanent dental restoration 100 so that it can be used for a temporary dental restoration 100.

For this purpose, regions of the permanent dental restoration 100 with stresses within the stress distribution 113 of the local region above a predetermined threshold value for the production material with the lower strength are reinforced. For example, the connecting cross-section at the interdental spaces is increased.

Depending on the simulation result of the spatial stress distribution 113, predetermined material-specific minimum values, such as for a wall thickness or cross-sectional area of the dental restoration 100, must not be complied with necessarily. For example, if the simulation allows for a wall thickness which is below the material-specific minimum value for the wall thickness, the dental restoration 100 can be produced with the reduced wall thickness.

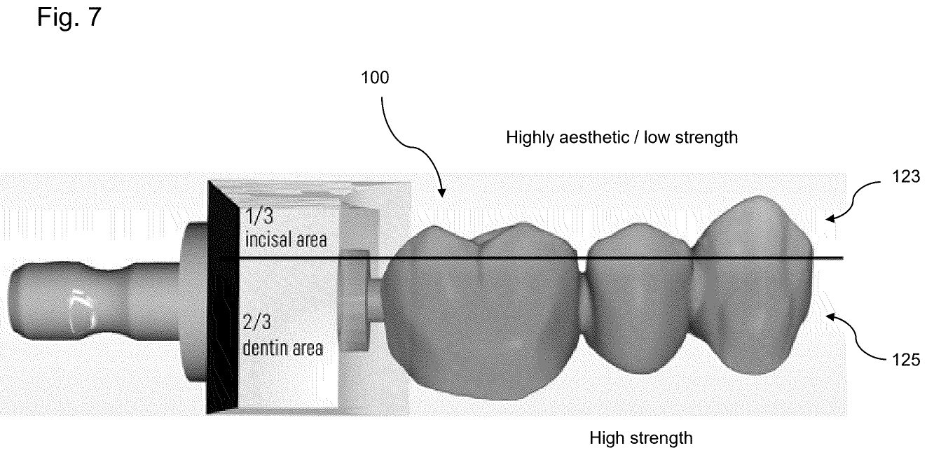

FIG. 7 shows a view of a dental restoration 100 with different strength values. The three-dimensional data set 103 can additionally indicate a distribution of strength values of the production material within the dental restoration 100. The spatial stress distribution 113 within the dental restoration 100 can be calculated for a predetermined load 105 based on the three-dimensional data set 103 with the corresponding distribution of strength values.

For example, the dental restoration 100 to be simulated comprises an incisal area 123 made of a highly esthetic production material with lower strength and a dentin area 125 with a high-strength production material. When simulating the stress distribution, the different strength values of the production material are also taken into account.

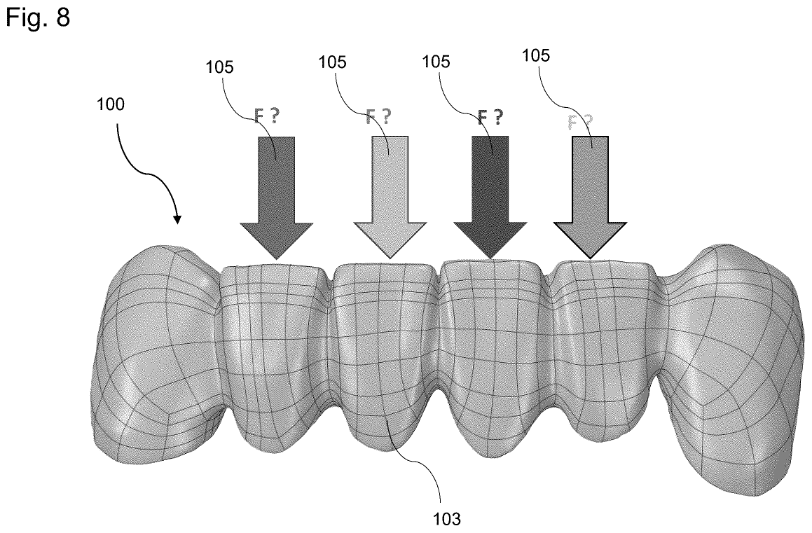

FIG. 8 shows a view of a change in the load site on the dental restoration 100. The size, position and/or direction of the load 105 can be changed in each case for a simulation of the stress distribution 113. For example, a predetermined load 105 is applied at different positions of the dental restoration 100 when simulating the spatial stress distribution 113.

For each size, position and/or direction of the load 105, a spatial stress distribution 113 within the dental restoration 100 can be calculated based on the three-dimensional data set 103. The calculated stress distributions 113 for each load can be compared with each other in order to find a critical load site. For example, the critical load site is indicated by the stress distribution 113 that has the largest maximum value of stress within the stress distribution 113 or the largest average value of stress within the stress distribution 113. The magnitude, position and/or direction of the critical load 105 can then be determined from the stress distribution with the largest maximum value of the stress or the largest average value of the stress.

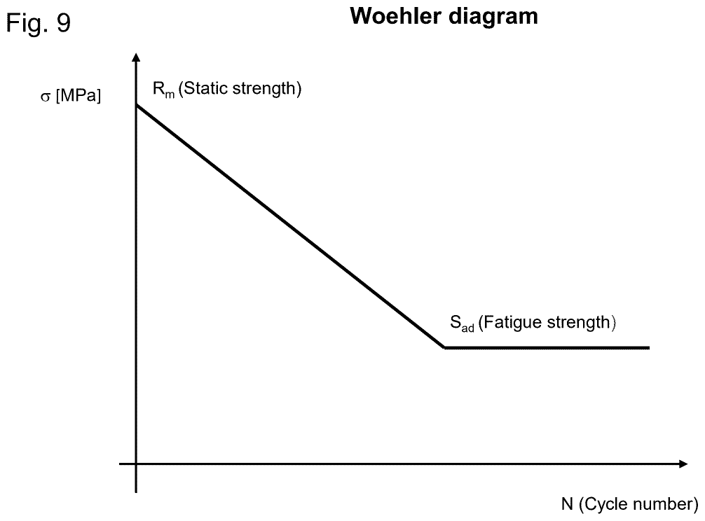

FIG. 9 shows a diagram for a static fracture and a fatigue fracture of the dental restoration 100. Two different load scenarios can be considered in the simulation in order to evaluate the mechanical stability of the dental restoration 100. On the one hand, the static fracture of the dental restoration 100 can be considered, which is caused by a one-time higher force, for example by biting on a cherry stone. In this case, the calculated stresses are compared with the static strength Rₘ.

On the other hand, the fatigue fracture of the dental restoration 100 due to daily cyclical chewing movements can be considered. Here, the calculated stresses are compared with the fatigue strength S_{ad}. The three-dimensional data set 103 can be adapted based on the simulated stress distribution 113 if, for example, a stress within the stress distribution 113 is above the static strength Rₘ or the fatigue strength S_{ad} of the dental restoration.

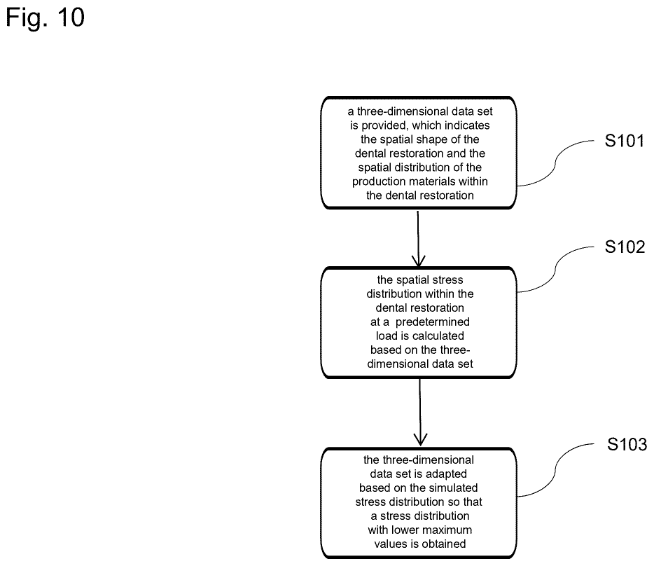

FIG. 10 shows a block diagram of a method of building the dental restoration 100. In step S101, the three-dimensional data set 103 is provided, which indicates the spatial shape of the dental restoration 100 and the spatial distribution of the production materials 101 within the dental restoration 100. The data set 103 may be stored in a digital memory, such as a RAM memory, a hard disk memory, a database or an optical or magnetic storage medium. In addition, the data set may comprise the material properties of the production materials 101. These material properties can also be retrieved from a database.

The three-dimensional data set 103 of the dental restoration 100 is created, for example, based on a CAD model with an STL interface. The STL interface describes the surface of the dental restoration 100 using triangular facets (“tessellation”). Each triangular facet 107 of the surface is characterized by the three corner points and the associated surface normal of the triangle.

When providing the three-dimensional data set 103, the size of the triangular facets 107 can be changed in order to obtain a more precise stress distribution 113. For example, the size of the triangular facets 107 is reduced in regions where high stresses are expected.

Subsequently, in step S102, the spatial stress distribution 113 within the dental restoration 100 at a predetermined load 105 is calculated based on the three-dimensional data set 103.

For this purpose, for example, a computer program is executed by a processor of a computer which has access to the digital memory in which the three-dimensional data set 103 and/or further programs for processing are stored. The computer program comprises instructions or commands that cause the computer to perform the above-mentioned steps. The computer is, for example, a personal computer, a tablet PC or a workstation. However, the method may also be performed by a computer network.

Considering the shape and material distribution of the dental restoration 100, the stress distribution 113 within the dental restoration can then be calculated. This generally results in different stresses at different locations of the dental restoration 100.

In step S103, the three-dimensional data set 103 is adapted based on the simulated stress distribution 113 so that a stress distribution 113 with lower maximum values is obtained. Here, the spatial shape of the dental restoration 100 and/or the composition and local distribution of the production materials 101 can be changed. These steps can be repeated iteratively until a stress within the stress distribution 113 falls below or exceeds a predetermined value. For example, the shape is reduced until the predetermined value is exceeded for the first time. Then, the iterative repetition is terminated and it is returned to the shape one step before in which the threshold value was not exceeded.

The method can also provide recommendations as to which production materials are particularly suitable for certain dental restorations 100.

After the method has been completed, the three-dimensional data set 103 obtained in this way can be transferred to a production apparatus 200, which produces the dental restoration 100 accordingly using a suitable production process. The data set 103 provides the mesh coordinates of the three-dimensional data model of the dental restoration 100 for production by means of subtractive or additive production processes/3D printing or rapid prototyping systems.

All the features explained and shown in connection with individual embodiments of the invention can be provided in different combinations in the subject-matter according to the invention in order to simultaneously realize their advantageous effects.

All method steps can be implemented by devices that are suitable for executing the respective method step. All functions performed by the features of the subject-matter can be a method step of a method.

The scope of protection of the present invention is given by the claims and is not limited by the features explained in the description or shown in the figures.

### REFERENCE LIST

100 dental restoration
101 production material
103 data set
105 load
107 triangular facet
109 region
111 lateral surface
113 stress distribution
115 force vector
117 occlusal surface
119 metal bar
121 temporary dental restoration
123 incisal area
125 dentin area
200 production apparatus

1. A method of building a dental restoration, comprising the steps of:
providing a three-dimensional data set indicating a spatial shape of the dental restoration and a spatial distribution of at least one production material within the dental restoration;
simulating a spatial stress distribution within the dental restoration at a predetermined load based on the three-dimensional data set; and
changing the three-dimensional data set based on the simulated spatial stress distribution.

2. The method according to claim 1, wherein a surface of the dental restoration is imaged by triangular facets.

3. The method according to claim 2, wherein the triangular facets have a smaller area in a region between two teeth or in a region of an occlusal surface than in another region of the dental restoration.

4. The method according to claim 1, wherein the spatial shape of the dental restoration is changed.

5. The method according to claim 4, wherein a local region of the shape is expanded if a stress within the stress distribution of the local region is above a predetermined threshold value, and/or the local region of the shape is reduced if the stress within the stress distribution of the local region is below a predetermined threshold value.

6. The method according to claim 4, wherein a connecting cross-section between two teeth of the dental restoration is increased if a stress within the stress distribution is above a predetermined threshold value, and/or the connecting cross-section between two teeth of the dental restoration is reduced if the stress within the stress distribution is below a predetermined threshold value.

7. The method according to claim 1, wherein the at least one production material is replaced in a spatial region when a stress within the stress distribution is above or below a predetermined threshold value.

8. The method according to claim 7, wherein the at least one production material comprises a first production material assigned to a first spatial region of the dental restoration and a second production material assigned to a second spatial region of the dental restoration.

9. The method according to claim 1, wherein the simulated spatial stress distribution is simulated again with a changed spatial shape and/or a changed production material.

10. The method according to claim 1, wherein the method steps are repeated iteratively.

11. The method according to claim 10, wherein an iterative repetition of the method steps is terminated when a stress within the simulated spatial stress distribution falls below or exceeds a predetermined value.

12. The method according to claim 1, wherein the three-dimensional data set is transmitted to a production apparatus.

13. The method according to claim 1, wherein a material-specific minimum value is reduced in the production of the dental restoration and/or a material-specific maximum value is exceeded in the production of the dental restoration.

14. The method according to claim 12, wherein the production apparatus is a 3D printer or a milling machine.

15. The method according to claim 1, comprising building the dental restoration.

16. A computer program product comprising program code which is stored on a non-transitory machine-readable medium, the machine readable medium comprising computer instructions executable by a processor, which computer instructions cause a controller to perform the method according to claim 1.

17. A production apparatus comprising the computer program product according to claim 16.
